(19) United States
(12) Patent Application Publication
(10) Pub. No.: US 2026/0131591 A1
(43) Pub. Date: May 14, 2026

(54) HOLOGRAM GREETING CARD

(71) Applicant: HOLOPOP LLC, Virginia Beach, VA (US)

(72) Inventor: Ash Gilpin, Virginia Beach, VA (US)

(21) Appl. No.: 19/388,532

(22) Filed: Nov. 13, 2025

Related U.S. Application Data
(63) Continuation-in-part of application No. 19/081,994, filed on Mar. 17, 2025.
Application No. 19/081,994 is a continuation of application No. 18/821,505, filed on Aug. 30, 2024, now Pat. No. 12,251,954.
(60) Provisional application No. 63/536,204, filed on Sep. 1, 2023.

(51) Int. Cl. B42D 15/04

(52) U.S. Cl. CPC B42D 15/042

(57) ABSTRACT

A method of generating a hologram using at least one panel, a pop-up screen secured to the at least one panel, and a platform on the inside of the at least one panel. The method includes deploying the pop-up screen, placing an electronic device on the platform that is in front of the pop-up screen, and displaying a visual image on the electronic device to generate a hologram. The visual image may be a video or stationary image used to generate the hologram. The at least one panel may comprise a greeting card, a book cover, or a folder, and the pop-up screen may be configured to deploy manually or automatically. In addition, the method may include scanning a quick response (QR) code to retrieve a corresponding hologram video for displaying on the electronic device for generating the hologram.

### CROSS-REFERENCE TO RELATED APPLICATIONS

This is a continuation-in-part application which is based upon U.S. application Ser. No. 19/081,994 filed Mar. 17, 2025, which is a continuation application of U.S. application Ser. No. 18/821,505 filed Aug. 30, 2024, which is based upon U.S. provisional Application No. 63/536,204 filed Sep. 1, 2023, the disclosures which are hereby incorporated by reference in their entirety.

### FIELD

The present invention relates to the field of greeting cards, and, more particularly, to a hologram greeting card.

### BACKGROUND

Traditional greeting cards are typically made from folded paper stock or cardstock and include printed text or images intended to convey a personal message or celebratory sentiment. Over time, enhancements such as pop-up elements, sound modules, and light-emitting diodes (LEDs) have been added to increase visual and emotional impact. While these embellishments add novelty, they remain largely two-dimensional or rely on simple mechanical motion and do not provide the type of immersive visual experience achievable with modern display technologies.

Some existing greeting cards incorporate small liquid crystal display (LCD) screens that allow a user to view a short prerecorded video stored in onboard memory. Although such video greeting cards can provide dynamic visual content, they are expensive to manufacture relative to conventional printed greeting cards. The inclusion of an LCD screen requires integrated circuits, speakers, control buttons, and batteries for power. The need for these electronic components not only increases material and assembly costs but also adds bulk and weight, limiting the flexibility and lifespan of the card once the batteries are depleted.

While these types of electronic greeting cards are desirable, the complexity of manufacturing them with embedded LCD screens and associated electronic components remains a significant drawback. Consumers often prefer greeting cards that can be mailed inexpensively, folded flat, and stored easily, yet still deliver a unique and memorable presentation. Thus, there is a need for an interactive greeting card that creates a high-tech visual effect such as a hologram, without requiring electronic display modules or batteries.

Recent developments in mobile technology and holographic projection techniques have enabled hologram effects to be generated using a smartphone or tablet display in combination with a transparent reflective screen positioned at an angle to the device. However, existing hologram display kits and do-it-yourself arrangements typically require separate assembly or rigid plastic components that are not suited for integration into a compact, foldable greeting card format. These kits may involve multiple panels, adhesives, and alignment steps that are cumbersome for a typical user, and the resulting structures do not easily collapse for storage or mailing.

Accordingly, there exists a need for a greeting card that provides a simple, low-cost, and battery-free structure that is cost effective to manufacture and is more entertaining than a typical video greeting card.

### SUMMARY

The present invention provides a hologram greeting card configured to deploy a holographic display structure through coordinated movement of scissor-type struts and accordion-style paper sidewalls. The hologram greeting card includes a first panel and a second panel joined together along an adjacent longitudinal edge. A pop-up base is mounted on the first panel and comprises a front wall, a rear wall, and a pair of accordion-style sidewalls extending therebetween. The accordion-style sidewalls are configured to expand outwardly when the card is opened and to collapse inwardly when the card is closed, thereby enabling the card to transition between a flat storage position and an expanded display position.

A top frame extends between upper edges of the front and rear walls of the pop-up base. A pop-up platform is positioned within the pop-up base on the first panel and includes a top surface configured to support an electronic device thereon, such as a smartphone or tablet. The top surface of the platform may be slightly elevated from the first panel to optimize the angular relationship between the electronic device and a pop-up holographic screen. The rear edge of the platform may be coupled to the rear wall of the pop-up base, and collapsible supports may be provided between the platform and the first panel to maintain rigidity during deployment.

An expandable backdrop is secured proximate a rear edge of the top frame, and a screen frame is attached to a front region of the expandable backdrop. A transparent or semi-reflective pop-up screen is mounted within the screen frame and oriented at an acute angle relative to the top surface of the platform when deployed. A pair of scissor-type support struts are pivotally connected between the top frame and the screen frame. When the greeting card is opened, the accordion-style sidewalls expand to raise the top frame, causing the scissor-type struts to extend and position the screen frame at a desired angle for holographic projection. When the greeting card is closed, the accordion sidewalls and scissor-type struts collapse in unison, allowing the screen frame to fold flat against the top frame.

The scissor-type support struts may include first and second arms joined at a central hinge, allowing for smooth folding and unfolding motion. The struts may further include frictional or locking joints to stabilize the deployed position. The accordion-style sidewalls may be formed from pleated paper, cardstock, or thin sheet material, and may include decorative graphics or reinforcement layers to enhance strength and appearance.

In certain embodiments, the pop-up base may further include a pull tab coupled to the front wall to assist in sliding or deploying the base. The pull tab may also include a quick response (QR) code printed thereon, which can be scanned by a user's electronic device to retrieve a corresponding hologram video. When the hologram greeting card is opened, the video may be displayed on the device resting on the platform, and the pop-up screen produces a holographic image viewable through the screen frame.

The hologram greeting card therefore provides a compact, foldable, and low-cost structure capable of generating a holographic display effect without requiring built-in electronics or batteries. The integration of scissor-type struts with accordion-style paper sidewalls enables synchronized deployment of the pop-up base and screen, ensuring precise angular alignment between the screen and the electronic device for consistent holographic projection. The entire structure may be produced from die-cut paper or cardstock using standard folding, adhesive, or interlocking assembly techniques, allowing for economical mass production and creative design variations.

Other aspects, advantages, and features of the present disclosure will become apparent after review of the entire application, including the following sections: Brief Description of the Drawings, Detailed Description, and the Claims.

### BRIEF DESCRIPTION OF THE DRAWINGS

The aspects and the attendant advantages of the embodiments described herein will become more readily apparent by reference to the following detailed description when taken in conjunction with the accompanying drawings wherein:

FIG. 1 is a perspective view of a hologram greeting card with a pop-up platform deployed and in accordance with particular aspects of the invention disclosed herein;

FIG. 2 is a perspective view of a pop-up platform of the hologram greeting card of FIG. 1 in a storage position;

FIG. 3 is a perspective view of the hologram greeting card in a closed position;

FIG. 4 is a cross-sectional view of the hologram greeting card of FIG. 1 taken in the direction of line 4-4 in FIG. 1;

FIG. 5 is a front elevational view of the hologram a with the pop-up platform in a deployed position;

FIG. 6 is a cross-sectional view of the hologram greeting card of FIG. 1 taken in the direction of line 6-6 in FIG. 1;

FIG. 7 is a right side elevational view of the hologram greeting card with the pop-up platform deployed;

FIG. 8 is a partial top detail view of a scissor-type of support struts in a flat storage position;

FIG. 9 is a top view of the hologram greeting card without an electronic device positioned on the pop-up platform;

FIG. 10 is a partial top detail view of the scissor-type support struts being deployed;

FIG. 11 is a top view of the electronic device placed on the pop-up platform in order to generate a hologram on a screen located below; and

FIG. 12 is a perspective view of the hologram greeting card without sidewalls with the scissor-type struts deployed.

### DETAILED DESCRIPTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

Referring now to FIG. 1, a perspective view of the hologram greeting card 100 is depicted in a fully opened and deployed condition, wherein all primary components are extended to form a self-supporting holographic display assembly. In this view, the first panel 102 lies flat along a support surface and provides the foundation for the pop-up base 112, while the second panel 104 extends in an opposing direction from the first panel 102 from a longitudinal hinge 115. The pop-up base 112 is configured to rise from the first panel 102 and defines an interior cavity in which a pop-up screen 164 is suspended. An accordion-style front wall 124 of the base 112 is positioned toward the viewer, an accordion-style rear wall 126 is orientated opposite the front wall 126, and a pair of accordion-style sidewalls 114, 116 extend laterally between them. Each sidewall 114, 116 is shown in its expanded state with a series of alternating pleats that project outward to maintain the spacing between the walls and to elevate a top frame 132 above the first panel 102.

The top frame 132 spans the upper edges of the front and rear walls 124, 126 and acts as a rigid bridge supporting a screen frame 162. A pop-up screen 164 of transparent or semi-reflective film is mounted within the screen frame 162. The screen 164 is oriented at an acute angle relative to the top surface of the platform 140 to provide the optimal geometry for holographic projection. The screen frame 162 is held in this angled position by a pair of scissor-type support struts 170, visible on opposite sides of the assembly. Each strut 170 extends diagonally between the top frame 132 toward the screen frame 162, illustrating the deployed “X-shaped” configuration of its intersecting arms. The open angle of the struts 170 locks the screen 164 at a fixed distance and orientation relative to the platform 140.

The platform 140 is shown centrally located within the pop-up base 112 and supported in part by the front platform wall 124 and rear platform wall 126. However, the support struts 170 provide substantially all the structural support to the platform 140. The top surface of the platform 140 may be elevated slightly above the first panel 102 to form a stable shelf for an electronic device 200. In FIG. 1, the electronic device 200 is depicted schematically resting on the top surface. The display screen of the device 200 faces downward toward the pop-up screen 164, allowing light from the video or animation displayed on the device to project onto the angled screen 164, thereby generating a floating holographic image. The spatial relationship between the screen 164 and the device 200 is maintained automatically by the combined action of the accordion sidewalls 114, 116 and scissor-type struts 170.

The pull tab 122 extends forward from the first panel 102 and may include printed indicia or a quick-response (QR) code. In the view of FIG. 1, the pull tab 122 is accessible to the user at the front edge of the card, enabling manual operation if desired. The QR code can be scanned by the electronic device 200 prior to placement on the platform 140 to retrieve a corresponding hologram video. Once the card 100 is deployed, the video plays on the device screen and reflects onto the pop-up screen 164, producing the desired three-dimensional holographic effect visible through the front of the structure.

The overall perspective of FIG. 1 demonstrates the coordinated movement of all major elements when the card 100 is deployed. This includes the accordion sidewalls 114, 116 expanding laterally and vertically, raising the top frame 132, the scissor-type struts 170 expanding to lift and angle the screen frame 162, and the platform 140 simultaneously elevating to its operational height. This synchronized deployment transforms the flat, two-panel greeting card into a miniature holographic theater requiring no electronics or powered actuators. When closed, all of these components fold neatly back into a flat configuration within the thickness of the first and second panels.

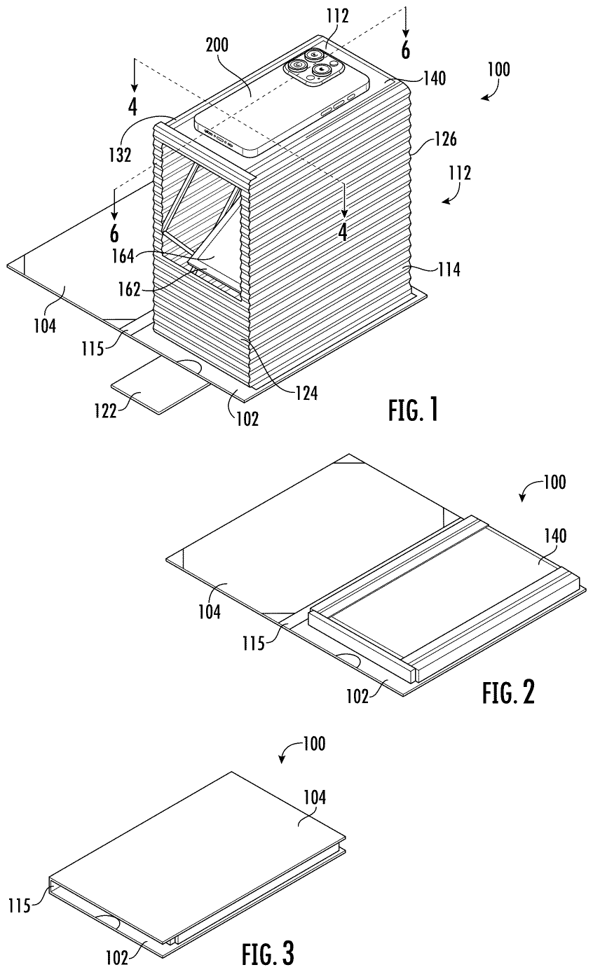

FIG. 2 illustrates the pop-up platform 140 and base 112 of the hologram greeting card 100 in a storage position, showing the configuration of the structural elements when the pop-up base 112 is collapsed but the card 100 is not closed. In this intermediate condition, the first panel 102 remains flat while the second panel 104 has not yet been folded over the hinge 116. The accordion-style sidewalls 114, 116 are shown folded with the pleats compressed. The top frame 132 lowers down towards the first panel 102, causing the scissor-type support struts 170 to pivot at their central hinges and assume a generally flattened “X” orientation.

In the configuration of FIG. 2, the top surface of the pop-up platform 140 lies substantially parallel to the first panel 102 and is resting on the folded front and rear platform walls 124, 126. The accordion walls may be formed as gusseted paper panels or angled linkages that collapse along predefined fold lines to permit the top surface to lower evenly as the pop-up base 112 compresses. The pleated accordion sidewalls 114, 116 act as guiding bellows to direct the vertical movement of the top platform 140 and ensure that the screen frame 162 and screen 164 folds symmetrically.

The pull tab 122 remains visible and accessible at the front edge of the card in this position, allowing the user to either manually extend the base 112 or complete the closing action. The scissor struts 170 are shown nested within the sidewalls. This collapsed condition illustrates the phase of operation when the card is in the flat stored configuration.

FIG. 3 illustrates the hologram greeting card 100 in a fully closed position. In this view, the second panel 104 has been folded over the first panel 102 along the hinge 115, enclosing the internal components of the pop-up base 112 and platform 140. The accordion sidewalls 114, 116 are completely folded with the pleats lying flat against one another, thereby bringing the front wall 124 and rear wall 126 into close proximity. The top frame 132 rests substantially flush against the first panel 102, and the screen frame 162 together with the pop-up screen 164 are folded flat within the thickness of the card body. The scissor-type struts 170 are completely collapsed, with their pivoting arms lying in an overlapping position.

The pull tab 122 may project slightly from the front edge of the closed card to permit easy re-deployment. The top surface of the platform 140 and the first panel 102 are now in near-contact, and all internal components are confined between the two panels 102, 104, creating a compact, planar form factor suitable for mailing in a standard envelope. The overall thickness of the card 100 in this closed condition is substantially uniform, typically no greater than a half-inch, due to the compressibility of the folded paper structures

In the closed position, the hologram greeting card 100 appears externally similar to a conventional folded greeting card and may include printed graphics, embossed patterns, or personalized messages on the exterior surfaces of the first and second panels 102, 104. The internal holographic display components remain concealed and protected within the folded card until the recipient opens it, at which point the accordion sidewalls 114, 116 automatically expand and the scissor struts 170 lift the pop-up screen 164 into the operational position shown in FIG. 1.

FIG. 4 is a cross-sectional view of the hologram greeting card 100 taken along line 4-4 of FIG. 1, illustrating the vertical relationships among the primary structural and functional elements in the deployed position. The first panel 102 lies horizontally at the bottom of the structure, and the pop-up base 112 extends upward therefrom. The accordion-style sidewalls 114, 116 are seen in cross-section as a series of pleated folds. These pleated folds act as compressible bellows that control the spacing while maintaining lateral rigidity.

The top frame 132 spans across the upper edges of the base 112 and provides a horizontal platform for the electronic device 200. The screen frame 162 supports the pop-up screen 164 at an acute angle relative to the top surface of the pop-up platform 140. In the view of FIG. 4, the screen 164 is positioned below the platform 140, defining a triangular viewing volume between the screen 164, the platform 140, and the top frame 132.

The scissor-type support struts 170 ensure that when the accordion sidewalls 114, 116 expand, the screen frame 162 is simultaneously lifted and angled into its operational position. The scissor mechanism thereby maintains consistent spatial separation and orientation between the screen 164 and the top surface of the platform 140.

The electronic device 200 is represented schematically in FIG. 4 resting on the top surface of the platform 140, with its display screen oriented downward toward the pop-up screen 164. Light from the device 200 reflects off the angled screen 164 to create the holographic image viewable a front opening 130.

This cross-sectional configuration shows how the combined action of the accordion-style sidewalls 114, 116 and the scissor-type struts 170 positions all elements in a stable geometric relationship. The resulting structure forms a compact optical assembly that maintains accurate angles and distances critical to holographic projection. The optical path extends from the device 200 downward to the reflective surface of the screen 164 and toward a line of sight of the viewer at the front of the card 100.

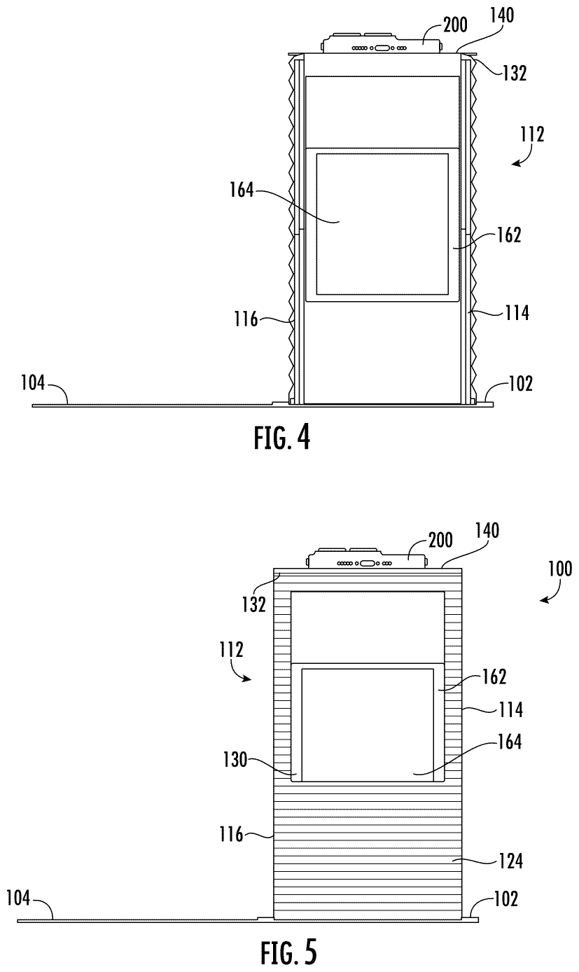

FIG. 5 is a front elevational view of the hologram greeting card 100 with the pop-up platform 140 in the deployed position, illustrating the symmetrical arrangement of the mechanical supports and visual display area. In this view, the front wall 124 of the pop-up base 112 forms the lower front boundary of the assembly, while the rear wall 126 is positioned behind the screen frame 162 and not visible from the front. The accordion sidewalls 114, 116 extend laterally and are visible at opposite sides as pleated paper panels that provide lateral stability and guide the vertical motion of the top frame 132.

The scissor-type struts 170 are located on the left and right sides of the display region and are shown in their expanded “X-shaped” configuration. The pivot points of the struts 170 are aligned along a common horizontal axis, ensuring symmetrical deployment on both sides of the card. The upper ends of the struts 170 connect to the top frame 132, while the lower ends slidingly engage with the first panel 102, maintaining a balanced mechanical linkage that supports the screen 164 at the desired viewing angle. In some embodiments, the scissor struts 170 may be slightly offset inward from the side edges of the top frame 132 to prevent interference with the accordion sidewalls 114, 116 during folding.

The screen frame 162 defines a rectangular opening through which the pop-up screen 164 is visible. The screen 164 itself may be formed from a transparent polyester film, a PET holographic projection material, or a thin reflective foil laminated to a paper frame. The acute angle between the screen 164 and the top surface of the platform 140 allows a holographic image generated by the electronic device 200 to appear floating in front of or behind the screen when viewed from the front of the card 100. The image region may occupy approximately the central third of the height of the card, providing an aesthetically balanced display window.

The pop-up platform 140 extends across the lower region of the structure and provides a stable surface for the electronic device 200. In the front view, the platform 140 may include decorative borders, printed indicia, or a recessed region that visually centers the device. The pull tab 122 extends forward from the bottom edge of the front wall 124 and may include the printed QR code. The QR code can be scanned using the electronic device 200 prior to placement on the platform, allowing the appropriate hologram video or image sequence to be downloaded and displayed.

FIG. 5 thus shows the hologram greeting card 100 in its active viewing configuration, where all mechanical and optical components are properly aligned. The accordion sidewalls 114, 116 provide lateral containment and visual framing, while the scissor-type struts 170 ensure the screen 164 remains stable at a precise viewing angle and supports the electronic device 200. The result is a self-deploying, paper-based holographic display platform that combines mechanical precision with the tactile appeal of a traditional greeting card.

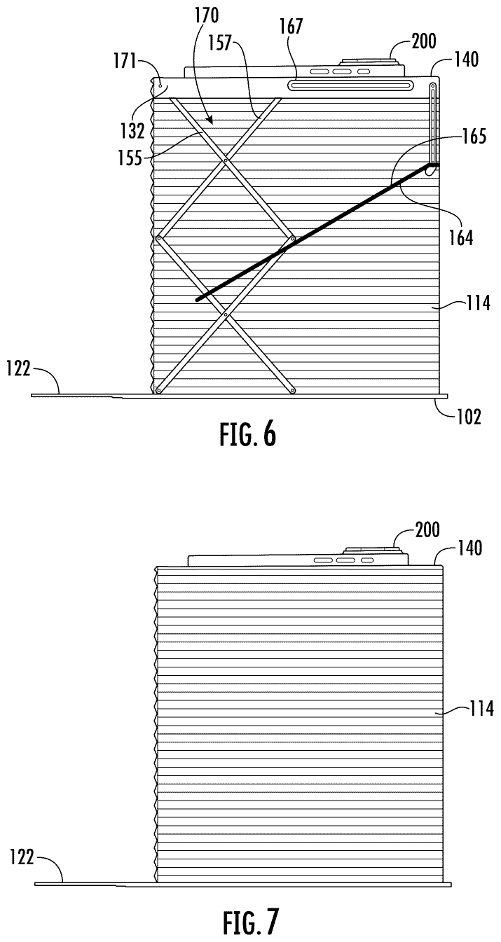

FIG. 6 is a cross-sectional view of the hologram greeting card 100 taken along line 6-6 of FIG. 1, illustrating the internal structure of the pop-up assembly in the transverse direction. This sectional view passes through one of the accordion-style sidewalls and a corresponding scissor-type support strut 170, providing a detailed representation of the interactive motion between these elements. The pleated folds of the sidewall are shown in their expanded condition, forming a series of alternating peaks and valleys that provide both vertical and lateral stability. The geometry of the pleats allows the sidewalls to compress and expand in a controlled manner, guiding the vertical displacement of the top frame 132 relative to the first panel 102.

The scissor-type support strut 170 is shown extending diagonally across the interior, with the upper arm pivotally secured to the side margin of the top frame 132 and the lower arm slidingly engaged with the first panel 102. The central hinges of the struts lie approximately midway between the top frame 132 and the first panel 102. When the pull tab 122 is pulled, causes the scissor struts 170 to unfold and push the top frame 132 forward and upward. Conversely, when the card 100 is closed, the collapsing pleats pull the top frame 132 downward, and the scissor struts 170 fold at their hinges into a compact, overlapping configuration. The sectional profile of FIG. 6 further illustrates that the front platform wall 124 and rear platform wall 126 are positioned within the boundaries defined by the accordion sidewalls 114, 116.

In this view, the longitudinal profile of the entire assembly is visible. The top frame 132 is positioned above the first panel 102 at a height approximately equal to the expansion of the accordion sidewalls 114, 116. The screen 164 extends downward and forward from the top frame 132, supported by the scissor-type struts 170 which appear as diagonally intersecting members on the right side of the assembly. A pivot 171 is located at a front portion of a side of the top frame 132 so that a first upper arm 155 of the scissor strut 170 is secured thereto. A slot 167 or groove is also formed proximate a rear portion of the side of the top frame 132 so that a second upper arm 157 is slidingly engaged. The pivot 171 and slot 167 are configured so that the scissor struts 170 are able to expand and collapse while the top frame 132 remains relatively horizontal to the first panel 102. A similar arrangement is located on the opposing side of the top frame 132 to engage with the scissor struts 170 on the opposing side.

The acute angle (α) between the pop-up screen 164 and the top surface of the platform 140 defines the holographic projection geometry. This angle may range between about 30 degrees and 60 degrees depending on the desired visual depth of the holographic image produced by the electronic device 200. The electronic device 200 rests securely on the platform 140, its display surface directed downward toward the pop-up screen 164. The light emitted from the device 200 reflects upon the inner face of the screen 164, producing a virtual image appearing to float in front of the screen when observed from the frontal direction.

In the side elevational view, the accordion sidewalls 114, 116 appear as layered pleats that act as expansion bellows controlling the upward movement of the top frame 132. Each pleat unfolds in harmony with the scissor-type struts 170, such that the motion of the sidewalls and struts is synchronized. The resulting kinematic linkage allows the screen 164 to deploy smoothly without distortion or binding of the paper folds.

FIG. 7 demonstrates the compact vertical alignment of the major structural elements when viewed from the side. The base 112 forms a rectangular structure rising from the first panel 102, and the top frame 132 defines the upper boundary of the assembly. The hologram greeting card 100 forms a stable, balanced structure that maintains the precise optical alignment necessary to produce a consistent holographic image whenever deployed.

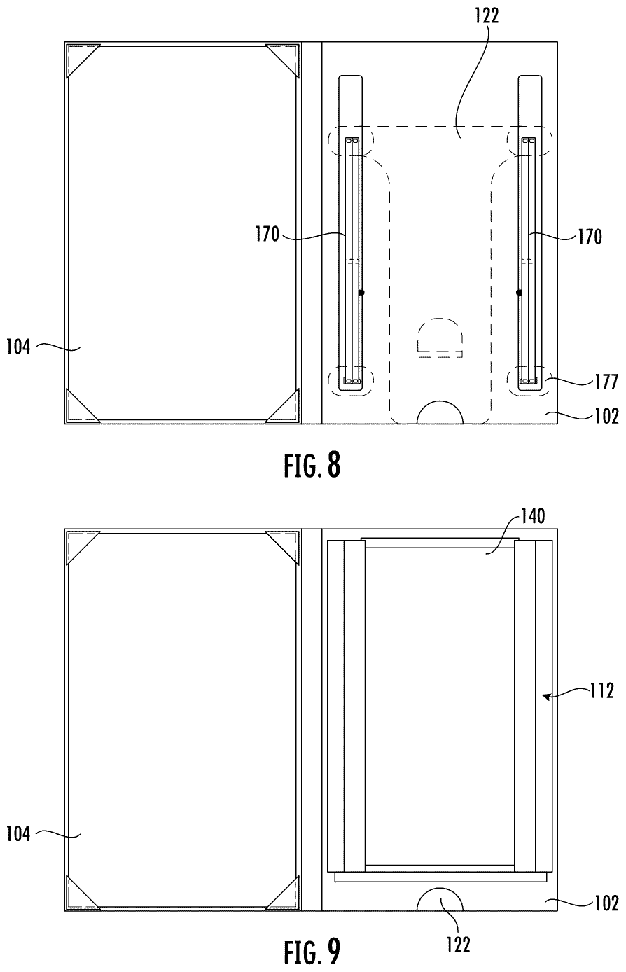

FIG. 8 is a partial top detail view of the scissor-type support struts 170 of the hologram greeting card 100 in their flat storage position. In this configuration, the greeting card is closed or collapsed, and the scissor mechanism is fully folded. Each scissor-type strut 170 comprises two lower arms and two upper arms joined at pivot hinges. The arms are preferably formed from die-cut paperboard, thin plastic, or laminated cardstock with sufficient stiffness to resist buckling when deployed.

In the top view of FIG. 8, the arms of the struts 170 are seen lying substantially parallel and overlapping along their lengths. The upper pivot points of the struts 170 are attached to corresponding sides of the top frame 132, while the lower pivot points of the struts 170 are slidingly engaged with the first panel 102. When the greeting card 100 is in its storage condition, the struts 170 rest in a flattened configuration within the lateral boundaries of the accordion sidewalls 114, 116. The folded pleats of the sidewalls surround the struts 170 and provide lateral containment. Adhesive reinforcement patches 177 may be placed at the pivot junctions to prevent tearing of the paper during repeated folding and unfolding cycles.

FIG. 9 shows a top plan view of the hologram greeting card 100. The top surface of the pop-up platform 140 is visible in FIG. 9 as a rectangular area centered within the base 112. The platform may include printed alignment markers or shallow recesses that indicate the placement position of an electronic device. Decorative graphics or instructions may be printed adjacent to the platform area to guide user interaction—for example, “Place your phone here and press play.” The pull tab 122 extends along the first panel 102 and remains exposed beyond the card edge for easy access.

FIG. 10 is a partial top detail view illustrating the scissor-type support struts 170 during deployment. This figure demonstrates the positions of the struts 170 as the greeting card 100 transitions from the collapsed to the deployed state. The lower pivot points on the first panel 102 remain substantially horizontal relative to the first panel 102, while the upper pivot points attached to the top frame 132 move forward and upward along an arc path. As the accordion sidewalls 114, 116 expand, the lateral distance between the top frame 132 and the screen frame 162 increases, causing the central hinge of each strut 170 to rise. The result is a smooth, synchronized lifting motion that translates the screen frame 162 from a flat resting position into a stable angled orientation within the pop-up base 112.

During this unfolding sequence, the two scissor-type struts 170 operate in tandem on opposite sides of the structure. The pivot geometry ensures that both sides of the screen frame 162 move evenly, preventing skewing or twisting of the pop-up screen 164. Frictional resistance at the hinge may be calibrated to create a gentle detent that holds the struts partially open, giving the card a tactile sense of tension as it nears full deployment. Once the card is fully open, the struts 170 lock into an extended “X” configuration, maintaining the desired angle between the screen 164 and the platform 140.

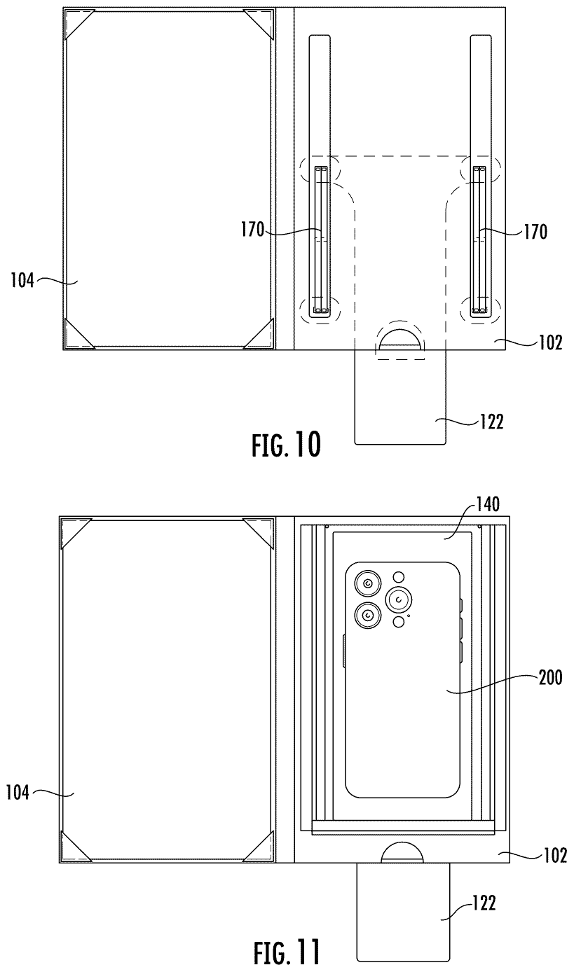

FIG. 11 is a top view of the hologram greeting card 100 with an electronic device 200 positioned on the pop-up platform 140 for generating a holographic image. In this operational configuration, the device 200 is centered on the top surface of the platform 140 and is oriented such that its display screen faces downward toward the pop-up screen 164. The optical path of the holographic projection extends downward from the device 200 to the reflective inner surface of the screen 164.

When the user initiates playback of the hologram video—retrieved, for example, by scanning the QR code on the pull tab 122, the content displayed on the device screen is reflected at an angle by the pop-up screen 164, producing a virtual holographic image. The viewer, looking through the front opening 130 of the card 100, perceives the image as floating in mid-air within the screen frame 162. The precise angular positioning maintained by the scissor-type struts 170 ensures that the reflected image appears properly aligned and stable even when the card is placed on a tabletop or other flat surface.

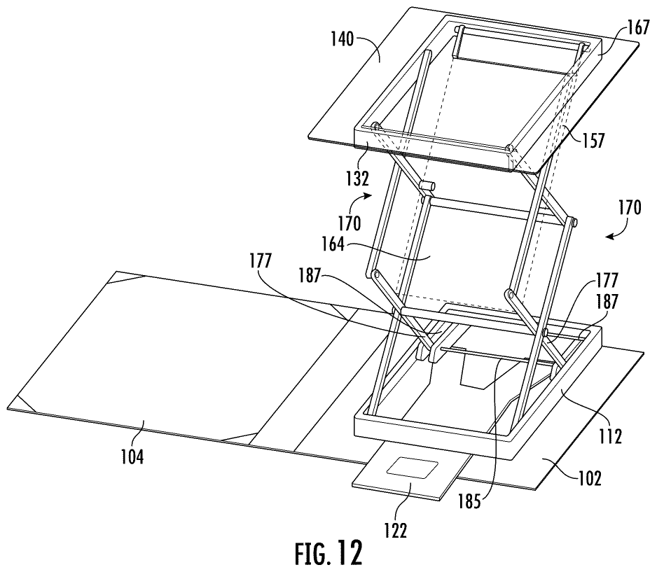

Referring now to FIG. 12, the scissor-type strut 170 is shown in a perspective view without the accordion-style sidewalls. The scissor-type support strut 170 is shown extending diagonally across the interior, with the lower arm 177 slidingly engaged with a slot or groove 187 within the side margin of the pop-up base 112. An axle 185 extends across the pop-up base 112 and connects the lower arm 177 on each side together. Accordingly, when the pull tab 122 is pulled, this causes the lower arm 177 of each of the scissor struts 170 to slide forward simultaneously within the side margin 187 and unfold the respective scissor strut 170 and push the top frame 132 upward. When the pull tab 122 is pushed inward, the axle moves rearward collapsing the scissor-type support struts 170.

Collectively, FIGS. 8-11 illustrate the mechanical and optical operation of the hologram greeting card 100 from its collapsed state through full deployment and active use. The scissor-type struts 170 act as precision linkages that ensure accurate angular positioning of the pop-up screen 164, while the accordion-style sidewalls 114, 116 provide synchronized expansion and support. The electronic device 200, when placed on the platform 140, cooperates with the pop-up screen 164 to create a visually striking holographic display. Upon closing, all components fold back neatly into the card body, preserving the thin, mailable profile characteristic of a traditional greeting card.

In operation, the hologram greeting card 100 transitions between a compact, folded configuration and a fully deployed holographic display through a coordinated sequence of mechanical movements involving the accordion-style sidewalls 114, 116, the scissor-type support struts 170, and the pop-up platform 140.

In the closed position, shown in FIG. 3, the second panel 104 folds over the first panel 102 along the longitudinal hinge 115. The accordion sidewalls 114, 116 are completely collapsed, and the pleats lie flat, drawing the front wall 124 and the rear wall 126 downward. The top frame 132, screen frame 162, and pop-up screen 164 lie flush within the thickness of the folded card. The scissor-type support struts 170 are fully folded at their central hinges, and the pop-up platform 140 rests relatively closely against the first panel 102.

When the user opens the greeting card 100 by separating the first and second panels 102, 104, and pulls the pull-tab 122, the accordion-style sidewalls 114, 116 begin to expand. The expansion of the pleats forces the top frame 132 upward relative to the first panel 102. This motion simultaneously initiates unfolding of the scissor-type struts 170, which extend at their central hinges to raise and tilt the screen frame 162 and pop-up screen 164 into an angled viewing position. The screen 164 becomes fully deployed at an acute angle (α) relative to the top surface of the platform 140.

As the sidewalls 114, 116 and scissor struts 170 reach their maximum extension, the pop-up platform 140 is elevated. The top surface stabilizes at an optimal height for supporting an electronic device 200, such as a smartphone. The mechanical geometry ensures that the screen 164 is positioned at a consistent distance and angle from the platform 140, maintaining a proper optical path for holographic projection.

To activate the holographic display, the user scans the quick-response (QR) code printed on the pull tab 122 using the camera or scanner function of the electronic device 200. The QR code links to a digital file containing a hologram video or image sequence compatible with the pop-up screen 164. The user then places the electronic device 200 flat on the top surface of the pop-up platform 140 with the device display facing downward toward the pop-up screen 164.

When the video is played on the electronic device 200, the light from the display reflects from the angled inner surface of the pop-up screen 164, producing a virtual holographic image visible to an observer positioned in front of the card. The image appears to float within the space between the screen frame 162 and the top frame 132, giving a three-dimensional visual effect. The scissor-type struts 170 and accordion sidewalls 114, 116 hold the geometry steady during viewing, preventing movement that could distort the holographic image.

Upon completion of the presentation, the user pushes the pull-tab 122 inward so that the accordion sidewalls 114, 116 compress inward, and drawing the front wall 124 and rear wall 126 down. The scissor-type struts 170 fold inward at the hinges, and the pop-up platform 140 simultaneously moves down towards the first panel 102, so that the entire mechanism returns to a flat, compact configuration suitable for mailing or storage.

This deployment and retraction sequence is fully mechanical, requiring no electrical power or active user assembly. The coordinated action of the accordion sidewalls 114, 116 and scissor struts 170 ensures smooth operation and long-term durability even after repeated openings and closings. The result is a self-deploying holographic display that transforms an ordinary greeting card into an interactive, visually dynamic experience using only folded paper mechanics and a user's existing electronic device.

The previous description of the disclosed embodiments is provided to enable any person skilled in the art to make or use the disclosed embodiments. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope possible consistent with the principles and novel features as defined herein.

1. A hologram greeting card comprising:
a first panel and a second panel joined together along an adjacent longitudinal edge;
a pop-up base having a front wall, a rear wall, and a pair of accordion-style sidewalls extending therebetween, the accordion-style sidewalls configured to expand outward when the greeting card is opened and to collapse inward when the greeting card is closed;
a top frame supported between upper edges of the front and rear walls of the pop-up base;
a pop-up platform positioned within the pop-up base on the first panel, the pop-up platform having a top surface elevated from the first panel and configured to support an electronic device thereon when the pop-up base is deployed;
an expandable backdrop having a bottom edge secured proximate a rear edge of the top frame;
a screen frame secured to a front of the expandable backdrop;
a pop-up screen secured within the screen frame; and
a pair of scissor-type support struts pivotally connected between the top frame and the screen frame and configured to expand to support the pop-up screen at an acute angle relative to the top surface of the pop-up platform when the expandable backdrop is deployed.

2. The hologram greeting card of claim 1, wherein the accordion-style sidewalls comprise pleated paper or cardstock configured to fold flat when collapsed and to maintain lateral spacing between the front and rear walls when expanded.

3. The hologram greeting card of claim 1, wherein each of the scissor-type support struts comprises a first arm and a second arm pivotally joined at a central hinge and configured to fold together when collapsed and extend apart when deployed.

4. The hologram greeting card of claim 1, wherein a rear edge of the top surface of the pop-up platform is coupled to the rear wall of the pop-up base.

5. The hologram greeting card of claim 1, further comprising a pull tab coupled to the front wall and configured to slide the front wall forward or outward to assist deployment of the pop-up base.

6. The hologram greeting card of claim 1, wherein the pop-up platform comprises a platform front wall and a platform rear wall that support the top surface of the pop-up platform therebetween.

7. The hologram greeting card of claim 6, wherein the pop-up platform further comprises a front collapsible support between the platform front wall and the first panel and a rear collapsible support between the platform rear wall and the first panel.

8. The hologram greeting card of claim 7, wherein the pop-up platform further comprises a vertical support coupled to the first panel between the platform front wall and the platform rear wall.

9. The hologram greeting card of claim 1, wherein the top frame comprises an opening aligned between the top surface of the pop-up platform and the pop-up screen to provide a viewing region for holographic projection.

10. The hologram greeting card of claim 5, further comprising a quick response (QR) code printed on the pull tab, wherein the QR code is configured to be scanned by a QR reader to retrieve a corresponding hologram video to display on the electronic device.

11. The hologram greeting card of claim 1, wherein the pop-up screen is oriented relative to the top surface of the pop-up platform when deployed to generate a hologram image.

12. The hologram greeting card of claim 1, wherein the second panel is configured to fold over the adjacent longitudinal edge to cover an entirety of the first panel in a closed position.

13. The hologram greeting card of claim 1, wherein the accordion-style sidewalls automatically expand upon opening of the greeting card to elevate the pop-up base and move the scissor-type struts into the deployed position.

14. The hologram greeting card of claim 3, wherein the scissor-type support struts include locking hinges or frictional joints configured to stabilize the screen frame in the deployed position.

15. The hologram greeting card of claim 1, wherein the pop-up screen comprises a transparent or semi-reflective film oriented at an acute angle relative to the top surface of the pop-up platform.

16. The hologram greeting card of claim 1, wherein the expandable backdrop comprises a folded paper sheet configured to rise vertically as the scissor-type struts deploy.

17. The hologram greeting card of claim 1, wherein the top frame and the pop-up base are formed from die-cut paper or cardstock and assembled using adhesive tabs or interlocking folds.

18. A hologram greeting card comprising:
a first panel and a second panel joined together along an adjacent longitudinal edge;
a pop-up base having a front wall, a rear wall, and accordion-style sidewalls extending therebetween;
a top frame supported between the front and rear walls;
a pop-up platform supported on the first panel and configured to support an electronic device thereon; and
a pop-up screen connected to the top frame by at least one scissor-type support strut configured to move between a collapsed and deployed position, wherein the pop-up screen is oriented at an acute angle relative to the top surface of the pop-up platform when deployed.

19. The hologram greeting card of claim 18, further comprising a QR code printed on at least one surface of the greeting card, the QR code configured to be scanned by a device to retrieve a holographic image or video for display.

20. A hologram greeting card comprising:
at least one panel;
a pop-up screen secured to the at least one panel and configured to move between a collapsed position and a deployed position via at least one scissor-type support strut; and
a platform on the inside of the at least one panel and positioned in front of the pop-up screen when the pop-up screen is in the deployed position, the platform configured for an electronic device to be positioned thereon, wherein the pop-up screen is oriented relative to the electronic device to generate a hologram when in the deployed position.
